(19) United States
(12) Patent Application Publication
(10) Pub. No.: US 2017/0030298 A1
(43) Pub. Date: Feb. 2, 2017

(54) ATOMIZING FUEL DELIVERY SYSTEM

(71) Applicant: Briggs & Stratton Corporation, Wauwatosa, WI (US)

(72) Inventors: Robert Koenen, Pewaukee, WI (US); Jason A. Hansen, Elkhorn, WI (US); Daniel Brueck, Brookfield, WI (US); Andrew J. Paskov, Brookfield, WI (US)

(73) Assignee: Briggs & Stratton Corporation, Wauwatosa, WI (US)

(21) Appl. No.: 15/223,776

(22) Filed: Jul. 29, 2016

Related U.S. Application Data
(60) Provisional application No. 62/199,693, filed on Jul. 31, 2015.

(51) Int. Cl. F02M 9/12; F02M 9/06; F02D 33/00; F02M 9/02

(52) U.S. Cl. CPC F02M 9/124; F02M 9/026; F02M 9/06; F02D 33/003; F02M 2200/21

(57) ABSTRACT

An engine that includes an air intake, a combustion chamber, an air passageway that is configured to channel air from the air intake toward the combustion chamber, a carburetor, a throttle plate, and a fuel atomizer. The carburetor includes a fuel bowl with a fuel well, a carburetor passageway that is fluidly coupled to the air passageway and configured to channel air and fuel to the combustion chamber, and a carburetor nozzle that has an inlet configured to receive fuel from the fuel well and an outlet disposed proximate to a constricted section of the carburetor passageway. The throttle plate is disposed downstream of the carburetor nozzle, and the fuel atomizer is configured to provide fuel to the carburetor passageway.

### CROSS-REFERENCE TO RELATED PATENT APPLICATIONS

This application claims the benefit of U.S. Provisional Application No. 62/199,693, filed Jul. 31, 2015, which is incorporated herein by reference in its entirety.

### BACKGROUND

The present invention relates generally to the field of fuel delivery systems. More specifically, the present invention relates to fuel delivery systems for engines configured to run outdoor power equipment, such as snow throwers.

Snow throwers and other types of outdoor power equipment are typically driven by an internal combustion engine. The engine includes a carburetor, which adds fuel to air flowing through the engine for combustion processes occurring within the engine. A throttle plate and a throttle plate may be used to control the flow rate of the air and air-fuel mixture flowing through the engine.

Electronic fuel injection may be used as a supplement to or a replacement for carburetor-based systems for delivering fuel for combustion processes. However, electronic fuel injection introduces additional complexities and costs to the engine.

In some cases, there is a time lag between when a throttle opens in response to an increase in load on the engine and when the carburetor increases the flow rate of fuel in response to the throttle. This results in a time period during which the engine may run more lean than desired or otherwise deliver insufficient power in response to the load.

### SUMMARY

One embodiment of the invention relates to an engine that includes an air intake, a combustion chamber, an air passageway that is configured to channel air from the air intake toward the combustion chamber, a carburetor, a throttle plate, and a fuel atomizer. The carburetor includes a fuel bowl with a fuel well, a carburetor passageway that is fluidly coupled to the air passageway and configured to channel air and fuel to the combustion chamber, and a carburetor nozzle that has an inlet configured to receive fuel from the fuel well and an outlet disposed proximate to a constricted section of the carburetor passageway. The throttle plate is disposed downstream of the carburetor nozzle, and the fuel atomizer is configured to provide fuel to the carburetor passageway.

Another embodiment relates to a fuel delivery assembly that includes an air passageway that is configured to channel air, a carburetor, and a fuel atomizer. The carburetor includes a fuel bowl with a fuel well, a carburetor passageway fluidly that is coupled to the air passageway and defines a constricted section, and a carburetor nozzle that has an inlet configured to receive fuel from the fuel well and an outlet disposed proximate to the constricted section. The fuel atomizer includes a piezoelectric actuator that is configured to provide fuel to a flow of air passing through the carburetor passageway.

Another embodiment relates to a carburetor that includes a fuel bowl, a piezoelectric fuel atomizer positioned within the fuel bowl and configured to atomize fuel disposed within the fuel bowl, and an outlet conduit coupled to the fuel bowl and configured to deliver atomized fuel to a manifold.

Alternative exemplary embodiments relate to other features and combinations of features as may be generally recited in the claims.

### BRIEF DESCRIPTION OF THE FIGURES

The disclosure will become more fully understood from the following detailed description, taken in conjunction with the accompanying figures, in which:

FIG. 1 is a perspective view of a snow thrower according to an exemplary embodiment of the invention.

FIG. 2 is a perspective view of an engine according to an exemplary embodiment of the invention.

FIG. 3 is a perspective view of a carburetor in a first configuration according to an exemplary embodiment of the invention.

FIG. 4 is a perspective view of the carburetor of FIG. 3 in a second configuration.

FIG. 5 is a perspective view of a fuel delivery system according to an exemplary embodiment of the invention.

FIG. 6 is a sectional view of the fuel delivery system of FIG. 5.

FIG. 7 is a perspective view of a fuel delivery system according to an exemplary embodiment of the invention.

FIG. 8 is a perspective view of a fuel atomizer assembly according to an exemplary embodiment of the invention.

FIG. 9 is a sectional view of the fuel atomizer assembly of FIG. 8.

FIG. 10 is a partial view of the fuel atomizer assembly of FIG. 8.

FIG. 11 is a perspective view of a fuel atomizer and control chip according to an exemplary embodiment of the invention.

FIG. 12 is a perspective view of an intake system according to an exemplary embodiment of the invention.

FIG. 13 is a perspective view of a fuel delivery system according to an exemplary embodiment of the invention.

FIG. 14 is a top view of a fuel bowl in accordance with the fuel delivery system of FIG. 13.

FIG. 15 is a schematic diagram of a fuel delivery system according to an exemplary embodiment of the invention.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

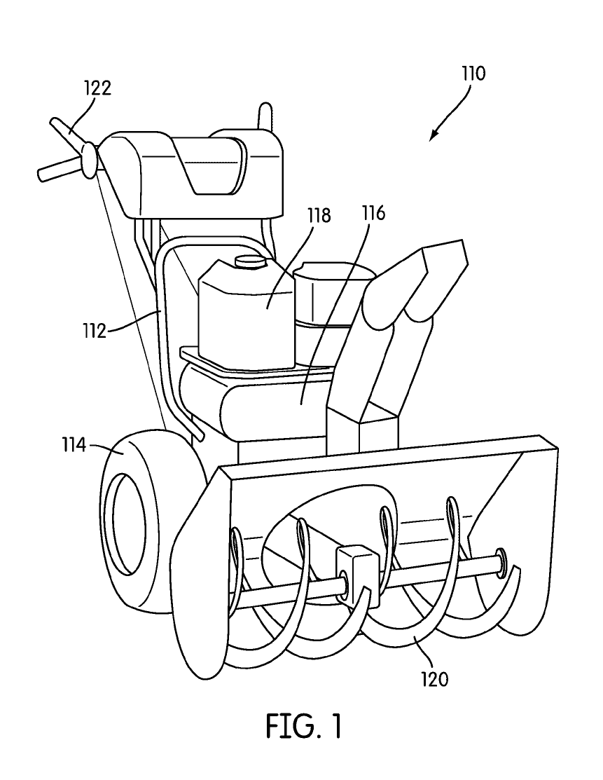

Referring to FIG. 1, outdoor power equipment, such as a snow thrower 110, includes a frame 112, wheels 114 coupled to the frame 112, an engine 116, and a fuel tank 118. The snow thrower 110 further includes a rotating tool in the form of an auger 120 that is configured to be driven by the engine 116. A control interface in the form of one or more of a throttle lever 122, on/off switch, and drive settings, or other features is coupled to the frame 112. While FIG. 1 shows the snow thrower 110, in other embodiments, outdoor power equipment may be in the form of a rotary tiller, a pressure washer, a snow thrower, a lawn tractor or riding mower, an edger, a portable generator, or other equipment, with a corresponding powered tool, such as tines, a pump, a blade, an alternator, a drive train, or other tools.

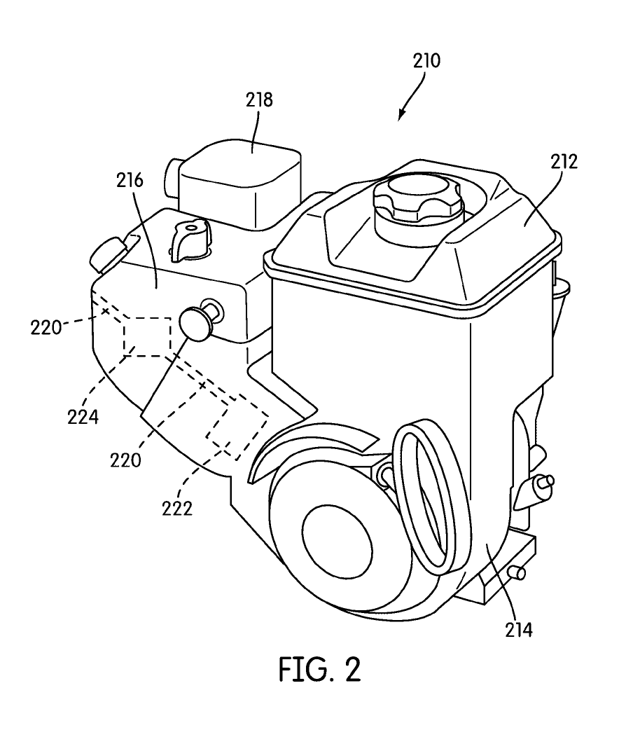

Referring to FIG. 2, an engine in the form of a small, single-cylinder, four-stroke cycle, internal combustion engine 210 includes a fuel tank 212, an engine block 214, an air intake 216, and an exhaust 218. Interior to the engine 210, the engine 210 includes a passageway 220 configured to channel air from the air intake 216 to a combustion chamber 222. Along the passageway 220, fuel is mixed with the air in a carburetor 224 or other fuel injection device. Combustion in the combustion chamber 222 converts chemical energy to mechanical energy (e.g., rotational motion; torque) via a piston, connecting rod, and crankshaft, which may then be coupled to one or more rotating tools (e.g., blade, alternator, auger, impeller, tines, drivetrain, etc.) of outdoor power equipment.

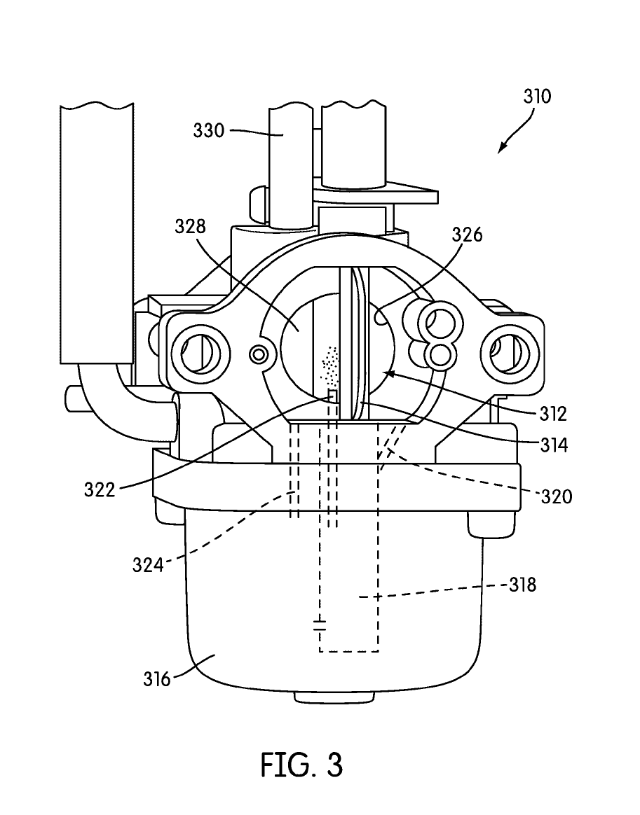

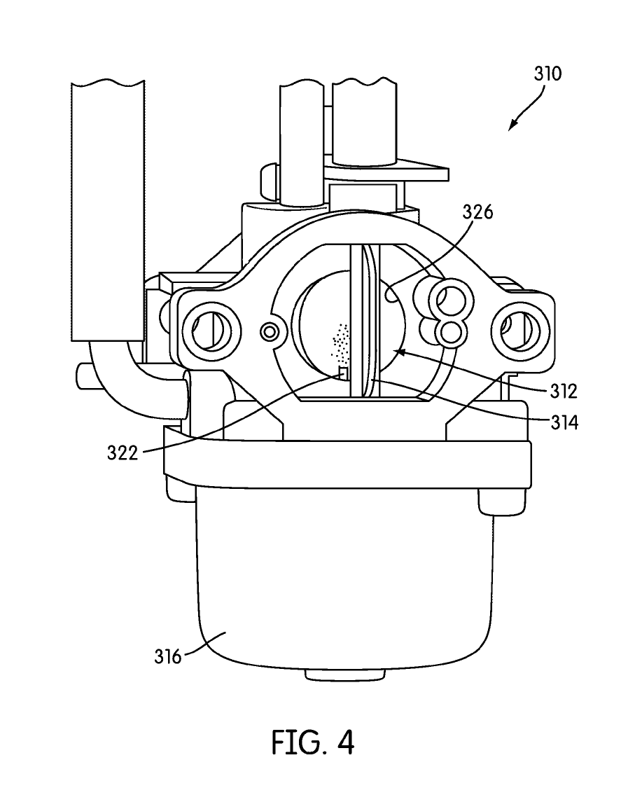

Referring now to FIGS. 3-4, a carburetor 310 for an engine (see, e.g., engine 210 as shown in FIG. 2) includes a throat 312 (e.g., conduit, passage, flow path) and, in some embodiments, at least one plate 314 (e.g., throttle plate, throttle plate, both throttle and throttle plates) configured to function as a butterfly valve to control the flow of air, or a mixture of fuel and air, through the carburetor 310. In FIGS. 3-4, the plate 314 is in an open configuration (e.g., wide-open throttle). According to an exemplary embodiment, the throat 312 of the carburetor 310 is positioned along a passageway extending from an air intake of the engine to a combustion chamber of the engine (see, e.g., passageway 220 as shown in FIG. 2).

The carburetor 310 is coupled to (e.g., in fluid communication with) a fuel tank (see, e.g., fuel tank 118 as shown in FIG. 1) by way of a fuel supply line or other conduit. The fuel tank may be mounted to the engine, integrated with the engine, or positioned on a frame of outdoor power equipment apart from the engine. In some embodiments the carburetor 310 includes a bowl 316 (e.g., container) that receives fuel from the fuel line. In some such embodiments, a float valve that includes a float coupled to a valve element is used to regulate the flow of fuel from the fuel line into the bowl 316. From the bowl 316, the fuel is delivered to a well 318 of the carburetor 310 (e.g., emulsion tube well), which is also coupled to a vent 320 and a nozzle 322. In some embodiments, air flows into the well 318 through the vent 320 and mixes with the fuel. Another vent 324 may be coupled to the bowl 316.

According to an exemplary embodiment, the carburetor 310 includes a constricted section 326 (e.g., narrower segment, venturi) integrated with the throat 312 that is bordered by wider portions of the passageway. The nozzle 322 of the carburetor 310 is directed into the passageway proximate to the constricted section 326, such as along the portion of the passageway closely following the most constricted portion of the constricted section 326. As air flows along the passageway through the carburetor 310, the velocity of the air increases through the constricted section 326. The increase in velocity corresponds to a decrease in pressure, which acts upon the nozzle 322, drawing fuel through the nozzle 322 and into the flow of air through the passageway.

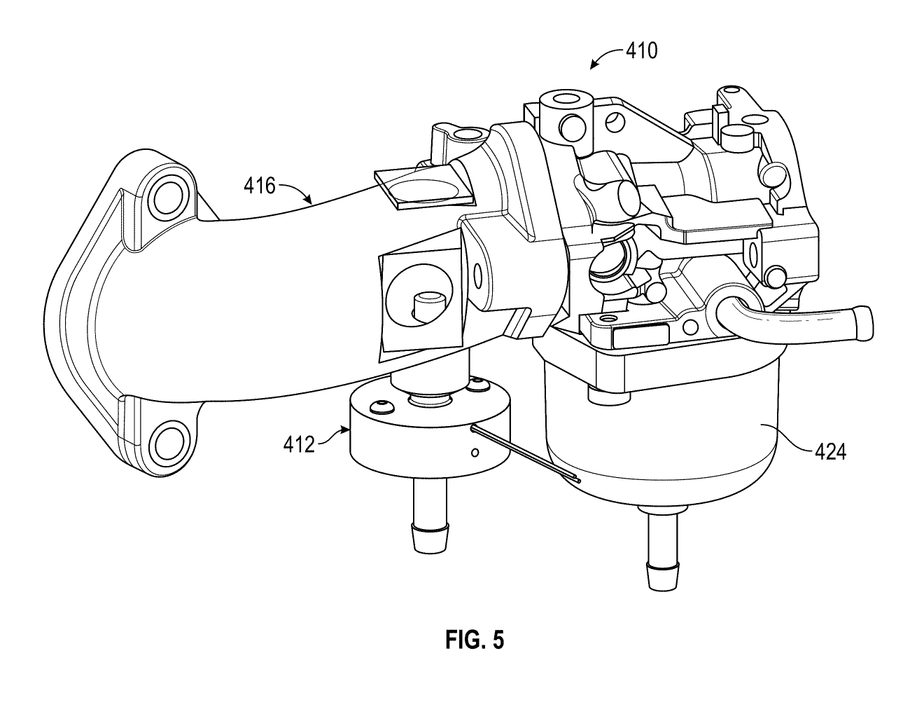

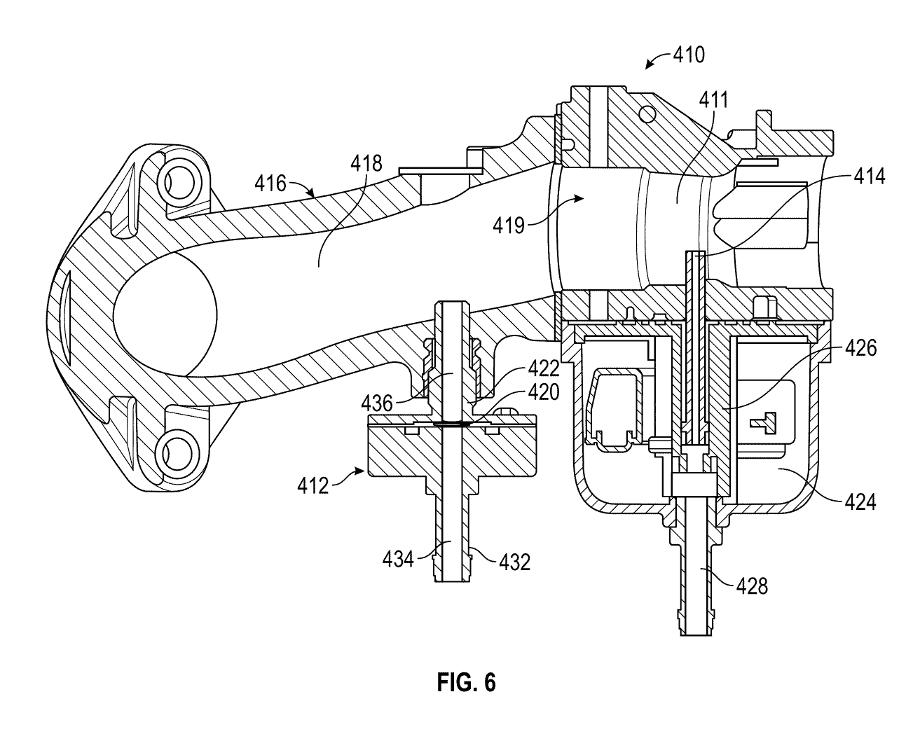

Referring to FIGS. 5-7, a carburetor 410 of an engine (e.g., engine 210 shown in FIG. 2) is provided along with a fuel atomizer assembly 412. The fuel atomizer assembly 412 is disposed upstream of a nozzle 414. The nozzle 414 is disposed proximate to a constricted section 411. The carburetor 410 includes a bowl 424 that may receive fuel, such as from a fuel line 428. The bowl 424 may be fluidly coupled to a well 426, which in turn is coupled to the nozzle 414 for delivering fuel into a flow of air passing through a passageway 418 into the carburetor 410. The carburetor 410 is disposed proximate to and downstream the passageway 418, and includes a carburetor passageway 419, such that a flow of air passing through the passageway 418 passes through the carburetor passageway 419 (e.g., the passageway 418 and the carburetor passageway 419 are coupled). The flow of air then passes into the combustion chamber (e.g. combustion chamber 222 shown in FIG. 2). In some embodiments, the fuel atomizer assembly 412, is positioned upstream or both a choke valve or choke plate, and a throttle valve or throttle plate.

The fuel atomizer assembly 412 includes a fuel atomizer 420 and an atomizer nozzle 422 directed into the passageway 418 of an air intake 416. The passageway 418 delivers air to pass through the carburetor 410 to a combustion chamber (e.g. combustion chamber 222 shown in FIG. 2). The fuel atomizer 420 is configured to atomize fuel (e.g., convert liquid fuel to vaporized fuel). Vaporized fuel may be delivered through the atomizer nozzle 422 into the passageway 418, mixing with air to reach the combustion chamber as an air-fuel mixture.

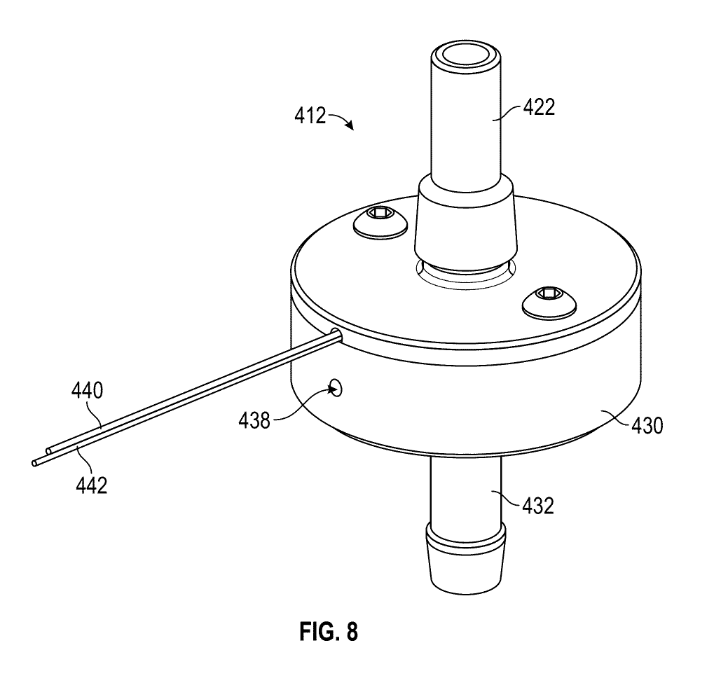

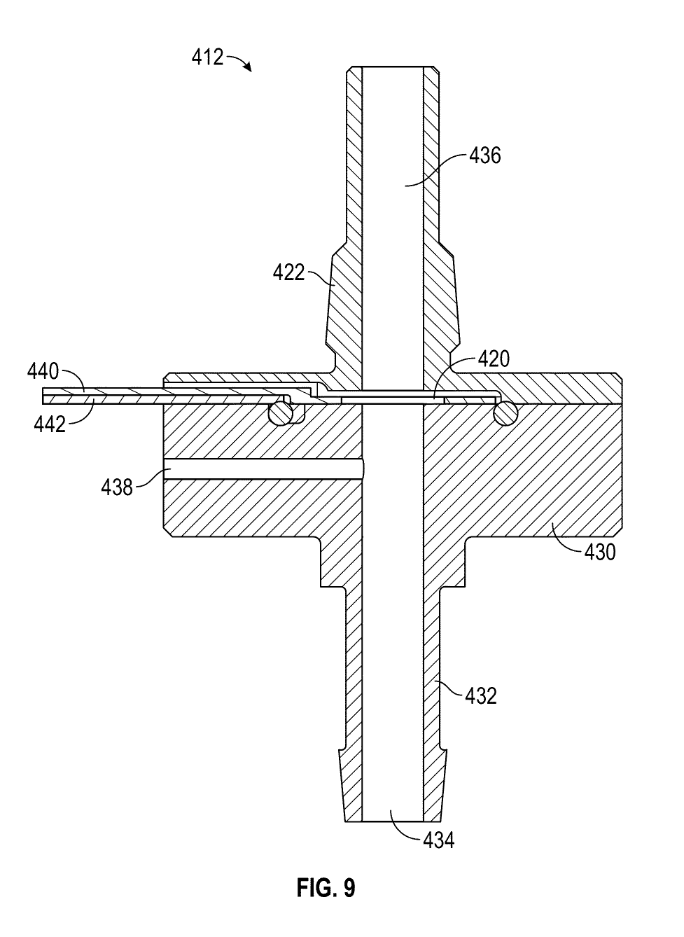

Referring to FIGS. 8-10, the fuel atomizer assembly 412 includes a fuel atomizer body 430, an atomizer inlet 432 including an atomizer inlet conduit 434, and the atomizer nozzle 422 including an atomizer nozzle conduit 436. The atomizer inlet 432 may receive fuel from a variety of sources (e.g., carburetor 410 shown in FIG. 5, fuel tank 212 shown in FIG. 2, etc.). The atomizer inlet 432 is disposed upstream of an atomizer housing 430 which houses the atomizer 420. The atomizer nozzle 422 is disposed downstream of the atomizer housing 430. The atomizer housing 430 may include a vent 438 which allows for air flow between atmospheric air and the atomizer inlet conduit 434.

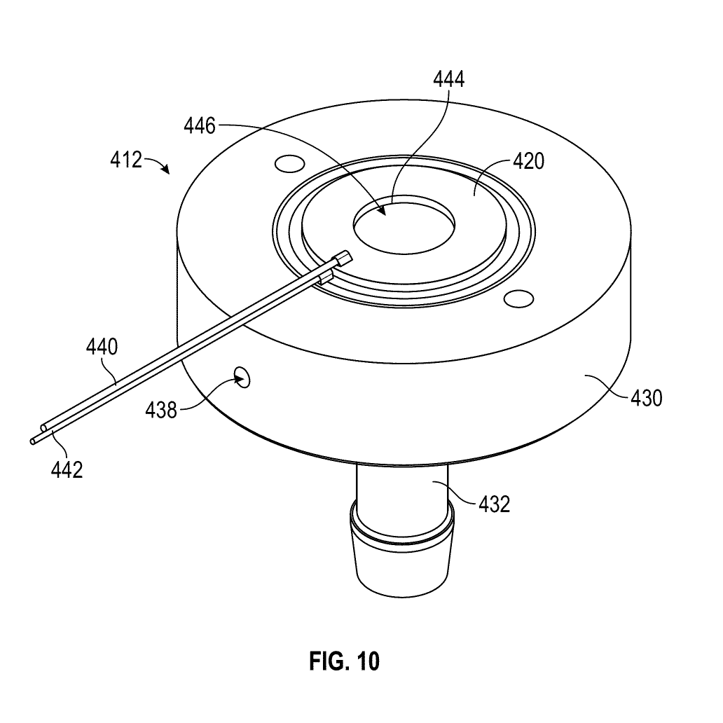

According to an exemplary embodiment, the fuel atomizer 420 comprises a piezoelectric actuator 446. For example, as shown in FIG. 10, the fuel atomizer 420 is provided as a disc (e.g., annular shape, washer-shaped, etc.) defining an inner opening 444 surrounding the piezoelectric actuator 446. The piezoelectric actuator 446 atomizes fluid (e.g., air, liquid fuel, etc.). For example, the fuel atomizer 420 is disposed between the atomizer inlet conduit 434 and the atomizer nozzle conduit 436, allowing the piezoelectric actuator 446 to interact with and atomize fluid passing from the atomizer inlet conduit 434 into the atomizer nozzle conduit 436.

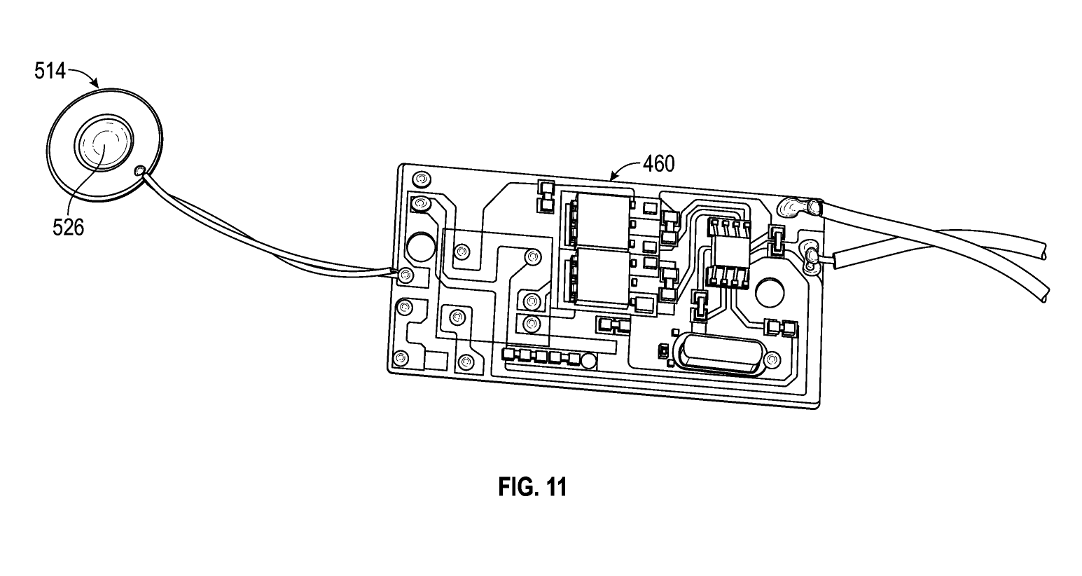

According to an exemplary embodiment, the piezoelectric actuator is configured to oscillate, vibrate, flex, or otherwise undergo mechanical motion in response to an electrical signal. The mechanical motion of the piezoelectric actuator 446 of the fuel atomizer 420 atomizes (e.g., vaporizes) fuel in contact with and/or proximate to the fuel atomizer 420. In various embodiments, the piezoelectric actuator 446 may be provided in various configurations (see, e.g., fuel atomizer 514 having a microporous piezoelectric actuator surface 526 as shown in FIG. 11, etc.).

The fuel atomizer 420, and particularly the piezoelectric actuator 446, may be powered by a power source remote from the fuel atomizer 420. For example, the piezoelectric actuator 446 may receive electrical power from an electrical power source (e.g., a battery) via electrical lines 440, 442. In some embodiments, electrical line 440 provides a positive side of an electrical circuit, while electrical line 442 provides a negative side of an electrical circuit. In some embodiments, the piezoelectric actuator 446 is configured to receive electrical signals via electrical lines 440, 442. For example, electrical lines 440, 442, may deliver a current (e.g. direct current, alternating current) to the piezoelectric actuator 446 in order to oscillate the piezoelectric actuator 446. In some embodiments, the current is approximately 2 amps (e.g., between 0 and 4 amps, between 1 and 3 amps, etc.). In some embodiments, the electrical signal is provided at a voltage of greater than 100 volts. In some embodiments, the electrical signal is provided at a voltage of approximately 12 volts (e.g., in conjunction with a 12 volt battery). In some embodiments, the electrical signal for driving the piezoelectric actuator 446 is provided (e.g., from a battery, from an energy storage device, etc.) for boost or cold start operations, or from an alternator (e.g., an alternator mechanically coupled to the engine 210) during other operations. In some embodiments, waste sparks are used to provide the electrical signal to the fuel atomizer at approximately 100 volts; waste sparks may also be used to store energy in a capacitor, battery, or other energy storage device, which then discharges electricity to drive the piezoelectric actuator 446.

According to an exemplary embodiment, the flow rate of fuel atomized (e.g., vaporized) by the fuel atomizer 420 is controlled by modifying the voltage of an electrical signal delivered to the fuel atomizer 420. For example, the amplitude of an AC voltage of an electrical signal delivered to the fuel atomizer 420 may be increased in order to increase the mechanical motion (e.g., flexing) of the piezoelectric component of the fuel atomizer 420 and increase the amount of fuel being atomized. In some embodiments, the amplitude of the mechanical motion of the piezoelectric component of the fuel atomizer 420 may be modulated based on the amplitude of the voltage delivered, while the frequency of the mechanical motion remains constant. As another example, the voltage delivered to the fuel atomizer may be pulse width modulated to control the mechanical motion (e.g., flexing) of the piezoelectric component of the fuel atomizer 420 and vary the amount of fuel being atomized as desired. Relative to an optimized frequency for the fuel atomizer being used, a high duty cycle would be used to increase the amount of fuel being atomized and a low duty cycle would be used to decrease the amount of fuel being atomized. The flow rate of the fuel atomized could also be controlled by eliminating (removing pulses from the electrical signal delivered to the fuel atomizer 420 (e.g., by eliminating particular cycles of the pulses—eliminate one pulse in five, one pulse in two, etc.—, by eliminating a pulse of a particular polarity—positive or negative, etc.).

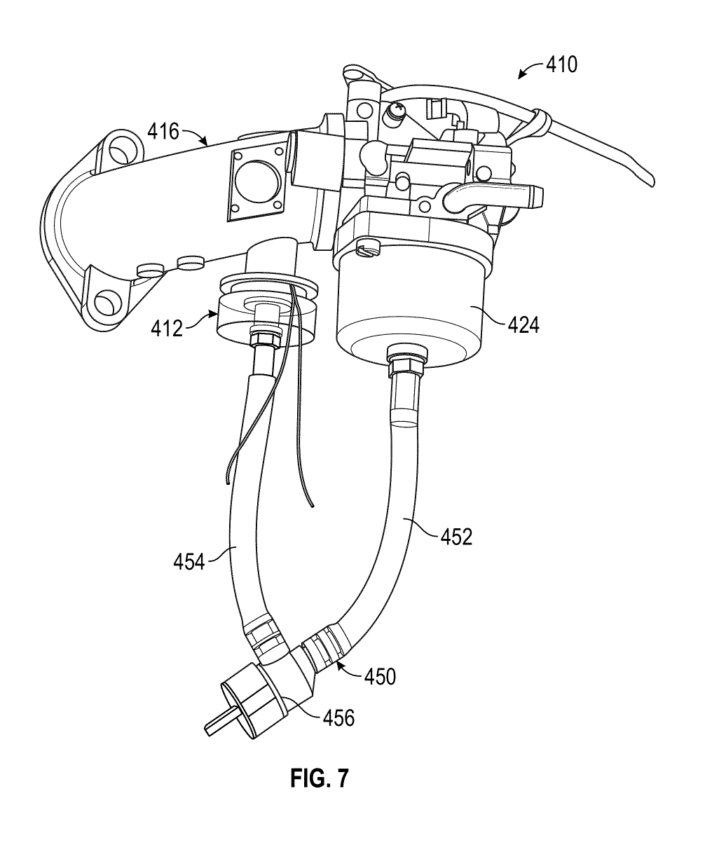

According to an exemplary embodiment, the fuel atomizer 420 uses the bowl 424 of the carburetor 410 as a fuel source. For example, as shown in FIG. 7, the bowl 424 and the fuel atomizer assembly 412 are coupled by a fuel line 450. The fuel line 450 includes a bowl outlet 452 coupled to an atomizer inlet 454. A valve 456 may be provided between the bowl outlet 452 and the atomizer inlet 454 to control a flow of fuel from the bowl 424 to the fuel atomizer assembly 412.

According to an exemplary embodiment, the fuel atomizer 420 is used to facilitate cold-start operation. The fuel atomizer 420 provides vaporized fuel to the air-fuel mixture drawn through the carburetor 410 into the combustion chamber (e.g., combustion chamber 222 of engine 210 shown in FIG. 2). The fuel-air mixture provided to the combustion chamber 222 during early cycles in the operation of the engine 210 is thus partially or fully vaporized without thermal energy from the combustion chamber 222, the ambient atmosphere, or other components of the engine 210. Cold-start operation using the fuel atomizer 420 may increase the efficiency (e.g., fuel efficiency) of operating the engine 210 by allowing the engine 210 to be run at stoichiometric or other efficient air-fuel ratios from the start of operation. Cold-start operation using the fuel atomizer 420 may increase the efficiency of operating the engine 210 by reducing the amount of unburned fuel during the start of operation.

In typical cold start operation, a throttle plate (e.g., a throttle plate disposed upstream of nozzle 322 shown in FIG. 4, etc.) is closed, which reduces a flow of air through the carburetor to create a rich air-fuel mixture to help initialize the combustion process. Typically, the throttle plate is closed for cold start operation by a manual process that could be automated using a fuel atomizer 420. For example, if a temperature sensor detects a temperature that is below a threshold, or if a user pushes a cold start button, the fuel atomizer 420 may respond by atomizing fuel and thus increasing the ratio of fuel to air in the air-fuel mixture being delivered to the combustion chamber 222. The temperature threshold may be the freezing point of water, a temperature related to a vapor pressure of the fuel, etc. The temperature sensor may detect an ambient temperature, a temperature of the fuel, a temperature within the engine, etc.

According to an exemplary embodiment, the fuel atomizer 420 is used to facilitate load response. For example, outdoor power equipment, such as the snow thrower 110 shown in FIG. 1, may encounter changes in elevation, changes in mass of snow to be thrown, etc., which apply an increased load to the snow thrower 110. The snow thrower 110 may thus be required to increase the power delivered to drive the snow thrower 110 while maintaining smooth operation (e.g., without requiring noticeable or significant control adjustments by an operator, etc.). In response to the load (e.g., as determined by a change in engine speed, a change in engine vacuum, a load sensor, etc.), the fuel atomizer 420 may increase the flow rate of fuel delivered to the combustion chamber 222, and thus the power delivered by the engine 210 for driving the snow thrower 110. In some embodiments, the fuel atomizer 420 is configured to atomize fuel between the time when a load signal is provided to the fuel atomizer 420 in response to a load, and when fuel from the carburetor 410 reaches a certain position (e.g., when fuel from the carburetor 410 reaches the nozzle 414, the constricted section 411, etc.). Currently, a lag may occur between an increase in load on the snow thrower 110 and the response of a throttle plate (e.g., throttle plate 314 shown in FIG. 4, etc.) to the load. Typically, increased load reduces engine speed, which is detected by a governor. The governor responds by opening the throttle plate 314 to maintain the engine speed at a set point. A time lag may occur between when the load increases, and when the governor is able to open the throttle plate 314 in response to the increase in load. The fuel atomizer 420 can supplement or replace the governor/throttle plate 314 action by adding fuel to the air-fuel mixture while the governor and throttle plate 314 are responding to the increase in load, thus mitigating or eliminating the time lag.

According to an exemplary embodiment, the fuel atomizer 420 is used to provide a power boost mode of operation. In the power boost mode, the flow rate of air delivered through the carburetor 410 may already be maximized (e.g., a throttle such as throttle 314 shown in FIG. 3 may already be in a wide-open throttle configuration). The fuel atomizer 420 provides additional fuel to the air-fuel mixture being delivered to the combustion chamber 222, even as the configuration of the carburetor is not changed. In some embodiments, the additional fuel provided by the fuel atomizer 420 may allow the engine 210 to be run at an optimal (e.g., selected for maximum power) air-fuel ratio (e.g., stoichiometric, slightly rich, etc.) while maintaining a maximum flow rate of air. The power boost mode may be activated by user operation of a user input device (e.g., button, switch, touchscreen, lever, etc.)

According to an exemplary embodiment, the fuel atomizer 420 is controlled by a controller or processing electronics (see, e.g., controller 460 shown in FIG. 11). The controller 460 may be configured to control the fuel atomizer 420 based on input signals (or control signals), such as signals from a sensor detecting qualities of the air-fuel mixture delivered to the combustion chamber 222, etc. For example, the controller 460 may be configured to control the fuel atomizer 420 in a closed-loop format, whereby the fuel atomizer uses feedback signals from a sensor to control the flow rate of atomized fuel until a target air-fuel ratio is reached. The controller 460 may be disposed in an electrical circuit between an energy storage device (e.g., a battery, a capacitor, etc.) and the electrical lines 440, 442, in order to control the properties of electricity delivered to the fuel atomizer 420. The controller 460 may receive input signals from a user/operator in order to control the fuel atomizer 420. In some embodiments, the control signal is configured to control the fuel atomizer 420 in an on/off mode of operation (e.g., the “on” signal causes the fuel atomizer 420 to atomize fuel at a predetermined rate, while the “off” signal causes to fuel atomizer 420 to not atomize fuel). In some embodiments, the control signal is configured to change (e.g., increase, decrease, ramp, etc.) the flow rate of fuel atomized by the fuel atomizer 420. In some embodiments, the controller 460 receives a load signal or a signal indicating a need for cold start operation, and controls operation of the fuel atomizer 420 based on the signal.

In some embodiments, the fuel atomizer 420 is configured for continuous or intermittent operation in the absence of a control signal; application of a control signal may then modulate the flow rate of fuel atomized by the fuel atomizer 420. For example, the fuel atomizer 420 may continuously atomize fuel at a low flow rate, and then receive a control signal that causes the fuel atomizer 420 to atomize fuel at a high flow rate.

In some embodiments, the fuel atomizer 420 is configured to only be activated in response to a specific signal. For example, the fuel atomizer 420 may typically be in an “off” mode in which it is not atomizing fuel, unless the fuel atomizer 420 receives a signal to operate in an “on” mode. In some embodiments, electrical signals are blocked from the fuel atomizer 420, such as by a shunt, etc., unless a control signal is delivered to open the shunt and allow the electrical signals to pass through to the fuel atomizer 420 in order to activate the fuel atomizer 420 so that the fuel atomizer 420 may atomize fuel.

In some embodiments, the control scheme used to control the fuel atomizer 420 may depend on the power source available to power the fuel atomizer 420. For example, an engine (e.g., engine 210 shown in FIG. 2) without a battery may include the fuel atomizer 420 that typically runs in an “off” mode unless a signal is delivered to turn the fuel atomizer 420 “on;” the engine 210 with a battery may include the fuel atomizer 420 that typically runs in an “on” mode, such as a continuous or intermittent mode of operation regardless of any control signals.

According to an exemplary embodiment, the fuel atomizer 420 is controlled based on a status of a throttle (e.g., throttle 314 shown in FIG. 3). For example, the position of the throttle 314 may be tracked (e.g., whether the throttle is in a wide-open position, whether the throttle partially or completely occludes a path for air and fuel to flow, etc.). An actuator may be mechanically coupled between the fuel atomizer 420 and the throttle 314, in order to modulate activity of the fuel atomizer 420 based on the position of the throttle 314. The controller 460 may be configured to receive throttle data including data regarding the position of the throttle 314 (e.g., via a sensor, via a mechanical device responsive to the position of the throttle 314, etc.), and modulate electrical signals delivered to the fuel atomizer 420 based on the throttle data. In some embodiments, the fuel atomizer 420 is controlled based on a change in throttle position. For example, if the throttle opens by at least a first threshold angular measurement (e.g., angle of the throttle relative to a reference position, etc.) in response to an increase in load, the fuel atomizer 420 may be configured to respond to such an increase in load by atomizing fuel. If the throttle closes by at least a second threshold angular measurement (e.g., angle, etc.) while the fuel atomizer 420 is activated, the fuel atomizer 420 may be configured to respond to such an increase in load by discontinuing atomizing of fuel.

According to an exemplary embodiment, the fuel atomizer 420 is controlled based on a load signal. A load signal may include a user input directing an increase in power to be delivered by the outdoor power equipment. A load signal may include sensor data such as a change in elevation detected (e.g., detected by a gyroscope), a change in power output required to drive a rotating tool (e.g., blade, alternator, auger, impeller, tines, drivetrain), an environmental condition such as temperature or humidity, a load detector output signal indicative of how hard the engine is running, a power boost signal indicative of the need or desire for more power, etc. The load signal may include data regarding an expected power output and/or air-fuel ratio, and the fuel atomizer 420 may be configured to adjust a rate of fuel atomization in response to the load signal.

According to an exemplary embodiment, operation of the fuel atomizer 420 is synchronized to an engine cycle. For example, the fuel atomizer 420 may time delivery of atomized (e.g., vaporized) fuel into the passageway 418 based on a spark timing of the engine cycle. The fuel atomizer 420 may time delivery of fuel into the passageway 418 to be a certain number of milliseconds (or crank angles, etc.) prior to the top dead center time of the engine cycle. A magnet or flywheel may be provided for spark timing. A gear tooth sensor (e.g., steel tooth, ferrous, etc.) may be provided on the flywheel. This can be used to time the atomizing of fuel so that the fuel added by the atomizer reaches the combustion chamber just prior to or at the intake cycle, so that the fuel added by the atomizer reaches the combustion chamber at a certain crank angle (e.g., between 0 and 10 degrees before top dead center, between 0 and 20 degrees before top dead center, between 10 degrees before top dead center and 10 degrees after top dead center, etc.).

In some embodiments, the fuel atomizer 420 may time delivery of fuel into the passageway 418 based on a distance from the fuel atomizer 420 to another component of the engine, such as the nozzle 414, the combustion chamber (e.g., combustion chamber 222 shown in FIG. 2) or an intake port, along with a flow rate of air and/or fuel. As such, the fuel atomizer 420 can synchronize delivery of fuel to the combustion chamber 222 with delivery of fuel from the nozzle 414 of the carburetor 410.

According to an exemplary embodiment, the fuel atomizer 420 is activated in response to a sensor input from a sensor disposed on the carburetor 410. For example, a vacuum sensor may be disposed within the carburetor 410 in order to detect a pressure (e.g. vacuum pressure) within the carburetor 410. The fuel atomizer 420 may be configured to atomize fuel based on a difference between the detected pressure and a setpoint, such as a setpoint on an intake port.

In various embodiments, the fuel atomizer 420 is disposed in various locations in the engine (e.g., engine 210 shown in FIG. 2). For example, the fuel atomizer 420 may be disposed in the carburetor 410, such as in the constricted section 411, on an outlet (e.g., downstream) side of the carburetor, on an exit (e.g., downstream) side of the nozzle 414, etc. The fuel atomizer 420 may be disposed past (e.g., downstream) of the throttle (e.g., throttle 314 shown in FIG. 3), near or in an intake manifold, near or in a cylinder (e.g., proximate to an intake port), etc.

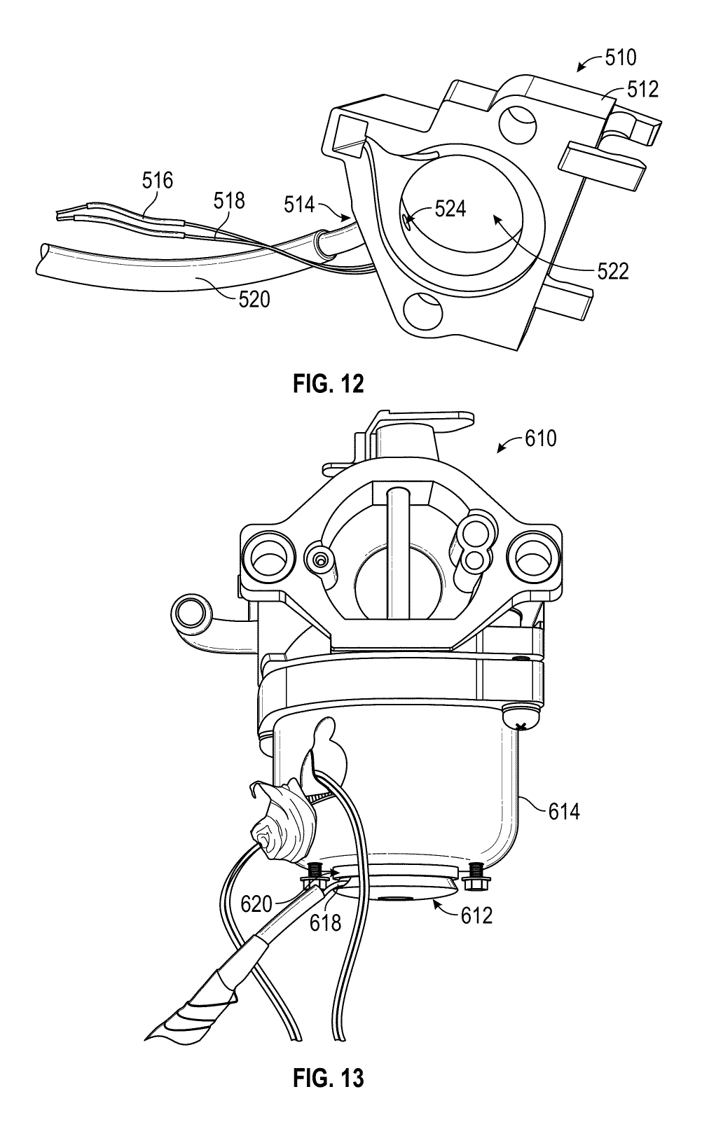

Referring to FIG. 12, an intake system 510 is disposed between a carburetor and a combustion chamber of an engine (e.g., carburetor 224 and combustion chamber 222 of engine 210 as shown in FIG. 2) and includes an intake manifold 512 and a fuel atomizer 514. The intake manifold 512 includes an intake conduit 522 through which air and fuel may pass to the combustion chamber. An outlet 524 couples the fuel atomizer 514 to the intake conduit 522. As shown in FIG. 11, the fuel atomizer 514 is provided as a microporous fuel atomizer 514. The microporous fuel atomizer 514 includes a microporous piezoelectric actuator surface 526. Liquid (e.g., liquid fuel) may contact a first (e.g., upstream) side of the microporous piezoelectric actuator surface 526 and pass through the second (e.g., downstream) side as vapor upon atomization by the fuel atomizer 514. The fuel atomizer 514 may be disposed in various orientations relative to a fuel line 520 and the intake conduit 522. For example, the fuel atomizer 514 may be oriented based on gravity such that the fuel line 520 is disposed generally higher than the fuel atomizer 514, such that gravity assists in delivering fuel to the fuel atomizer 514 and in turn to the intake conduit 522.

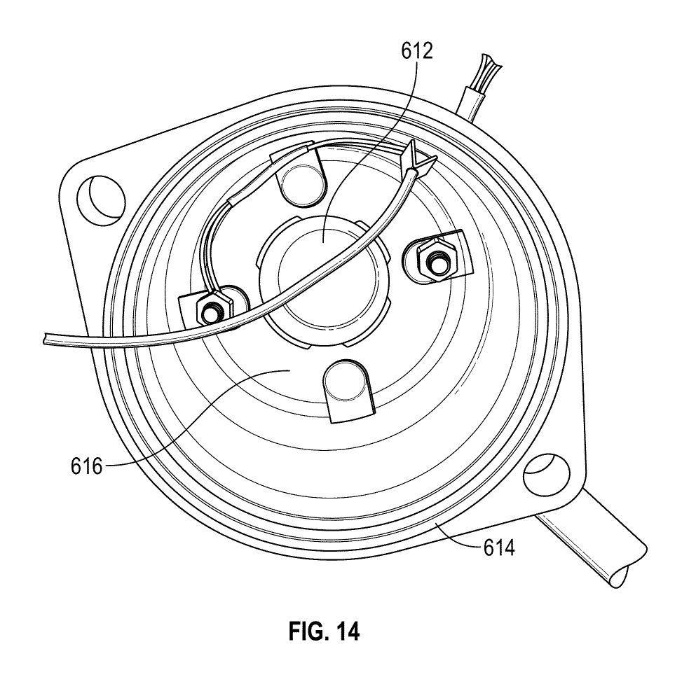

Referring to FIGS. 13-14, a carburetor 610 includes a fuel atomizer 612 disposed within a fuel bowl 614. As shown in FIG. 13, in some embodiments, the fuel atomizer 612 sits within a bottom surface 616 of the fuel bowl 614. The fuel atomizer 612 may be powered by a remote source, such as by electrical lines 618, 620 which may be electrically coupled to an electricity source (e.g., a battery). When activated, the fuel atomizer 612 atomizes fuel disposed above the fuel atomizer 612. As such, the amount of vaporized fuel delivered by the carburetor 610 to a combustion chamber (e.g., combustion chamber 222 shown in FIG. 2) is increased due to the fuel atomizer 612.

In some embodiments, the fuel atomizer 612 is disposed as a floating fuel atomizer 612 that floats above the bottom surface 616 of the fuel bowl 614. The fuel atomizer 612 may have a disc-like shape (e.g., annular shape, washer-shaped, etc.) with an opening allowing fluid to pass through the opening.

In various embodiments, by disposing the fuel atomizer 612 in the fuel bowl 614, the fuel atomizer 612 supplements the fuel delivered by the venturi of the carburetor 610. For example, the fuel atomizer 612 can increase the atomization of fuel relative to the venturi process alone, as would occur in a typical carburetor. The increased atomization of fuel reduces the amount of unburnt fuel, and thus increases fuel efficiency. Disposing the fuel atomizer 612 in the fuel bowl 614 may facilitate cold start operation, by reducing the amount of unburnt fuel delivered by the venturi to the carburetor 610.

In various embodiments, operation of the fuel atomizer assembly may be based on a signal indicating a demand for fuel, such as a load signal, a signal indicating that the engine should be started, a signal indicating that cold start operation is required, etc.

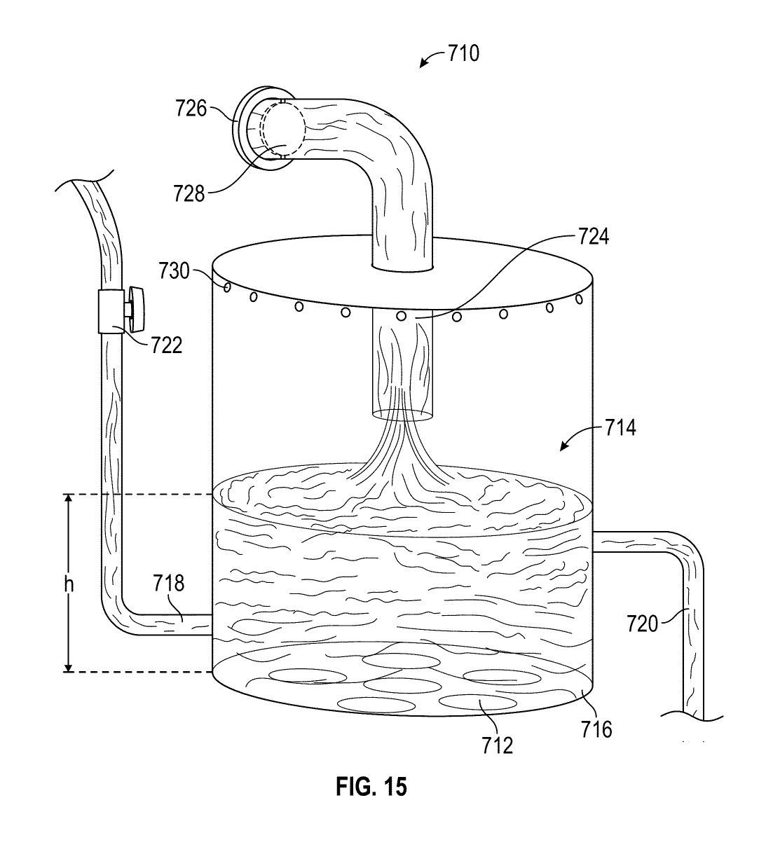

Referring to FIG. 15, a carburetor 710 includes a plurality of fuel atomizers 712 disposed along a bottom surface 716 of a fuel bowl 714. Fuel is provided to the fuel bowl 714 using a fuel inlet conduit 718. A fuel drain 720 is provided to facilitate maintaining the fuel level in the fuel bowl 714 at an optimum level h. A valve 722 may be provided to control the flow of fuel through the fuel inlet conduit 718 into the fuel bowl 714. The plurality of fuel atomizers 712 atomize (e.g., vaporize) fuel disposed within the fuel bowl 714. The vaporized fuel may exit the fuel bowl 714 through an outlet conduit 724. The outlet conduit 724 may terminate in a manifold attachment 726 for coupling the outlet conduit 724 to a manifold, such as an intake manifold for delivering fuel and air to a combustion chamber of an engine (e.g., combustion chamber 222 of engine 210 shown in FIG. 2). The outlet conduit 724 may include a throttle 728 for controlling a flow rate of fuel and/or air passing through the outlet conduit 724. The fuel bowl 714 may include vents 730 (e.g., holes, conduits, etc.) disposed along an outer surface 732 of the fuel bowl 714, allowing for air flow between atmospheric air and the fuel bowl 714.

The construction and arrangements of the fuel delivery system, as shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or other varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. An engine comprising:
an air intake;
a combustion chamber;
an air passageway configured to channel air from the air intake toward the combustion chamber;
a carburetor including
a fuel bowl including a fuel well,
a carburetor passageway fluidly coupled to the air passageway and configured to channel air and fuel to the combustion chamber, and
a carburetor nozzle including an inlet configured to receive fuel from the fuel well and an outlet disposed proximate to a constricted section of the carburetor passageway;
a throttle plate disposed downstream of the carburetor nozzle; and
a fuel atomizer configured to provide fuel to the carburetor passageway.

2. The engine of claim 1, wherein the fuel atomizer includes a piezoelectric actuator.

3. The engine of claim 1, wherein the fuel atomizer provides fuel to the carburetor passageway in response to a load signal.

4. The engine of claim 3, wherein the load signal is a function of at least one of a throttle position, a power boost signal, a load detector output signal, and an environmental condition.

5. The engine of claim 1, wherein the fuel atomizer includes an atomizer nozzle disposed upstream of the constricted section.

6. The engine of claim 5, wherein the atomizer nozzle is fluidly coupled to a portion of the air passageway between the air intake and the carburetor passageway.

7. The engine of claim 1, wherein the fuel atomizer is fluidly coupled to the fuel bowl of the carburetor.

8. The engine of claim 1, wherein a fuel supply line fluidly couples the fuel bowl of the carburetor and the fuel atomizer and a flow control valve controls a flow rate of fuel within the fuel supply line.

9. The engine of claim 1, wherein the fuel atomizer is configured to perform a cold start operation.

10. A fuel delivery assembly comprising:
an air passageway configured to channel air;
a carburetor including
a fuel bowl including a fuel well,
a carburetor passageway fluidly coupled to the air passageway and defining a constricted section, and
a carburetor nozzle including an inlet configured to receive fuel from the fuel well and an outlet disposed proximate to the constricted section; and
a fuel atomizer including a piezoelectric actuator configured to provide fuel to a flow of air passing through the carburetor passageway.

11. The fuel delivery assembly of claim 10, wherein the fuel atomizer is configured to provide the fuel in response to a load signal.

12. The fuel delivery assembly of claim 11, wherein the load signal is a function of at least one of a throttle position, a power boost signal, and a load detector output signal.

13. The fuel delivery assembly of claim 10, wherein the fuel atomizer is configured to perform a cold start operation.

14. A carburetor comprising:
a fuel bowl;
a piezoelectric fuel atomizer positioned within the fuel bowl and configured to atomize fuel disposed within the fuel bowl; and
an outlet conduit coupled to the fuel bowl and configured to deliver atomized fuel to a manifold.

15. The carburetor of claim 14, wherein the piezoelectric fuel atomizer is disposed on a bottom surface of the fuel bowl.

16. The carburetor of claim 14, wherein the piezoelectric fuel atomizer is configured to float within the fuel.

17. The carburetor of claim 14, wherein the fuel atomizer includes a piezoelectric actuator.

18. The carburetor of claim 14, wherein the fuel atomizer is configured to provide the fuel in response to a load signal.

19. The carburetor of claim 14, wherein the fuel bowl includes a vent disposed along an outer surface of the fuel bowl, the vent configured to allow a flow of air between the fuel bowl and atmospheric air.

20. The carburetor of claim 14, wherein the fuel atomizer is configured to perform a cold start operation.
